(19) United States
(12) Patent Application Publication
(10) Pub. No.: US 2011/0203408 A1
(43) Pub. Date: Aug. 25, 2011

(54) Quick release pedal mounting structure and system

(76) Inventor: Douglas M. White, Petaluma, CA (US)

(21) Appl. No.: 12/932,146

(22) Filed: Feb. 18, 2011

Related U.S. Application Data
(60) Provisional application No. 61/338,821, filed on Feb. 23, 2010.

(51) Int. Cl. B62M 3/00

(52) U.S. Cl. 74/594.3

(57) ABSTRACT

A releasable pedal mounting system having a pedal adapter that is adapted to engage a pedal and a pedal support member that is engageable to an apparatus, the support member including pedal adapter retention means that is adapted to allow mounting of the pedal adapter to the pedal support member when the pedal adapter retention means is in a first position and slideable engagement of the pedal adapter retention means to the pedal adapter retention region when in a second position, whereby the pedal adapter is secured to the pedal support member in a locked position.

### CROSS-REFERENCE TO RELATED APPLICATIONS

This application claims the benefit of U.S. Provisional Application No. 61/338,821, filed Feb. 23, 2010.

### FIELD OF THE INVENTION

The present invention relates generally to pedals and pedal mounting structures. More particularly, the present invention relates to a pedal mounting structure and system that is adapted to quickly release and attach pedals to a bike or other vehicle.

### BACKGROUND OF THE INVENTION

Historically, bicycles (or bikes) have provided a very flexible and inexpensive form of transportation and recreation. In fact, in recent years, bike sales have reached into the millions and are being widely used by many owners.

Bikes are thus often transported to various recreation or other locations. Many devices and systems have thus been designed to mount a bike to a vehicle to transport the bike. Such mounting equipment is often located at the rear or top of the vehicle.

Similarly, many devices have been designed to easily store the bike while not in use. These devices have provided means for mounting bikes on garage walls, or hang from garage ceilings, or on balconies, to name a few.

Additionally, because of the bike's versatility, bikes are often found being shipped to various recreation or other locations (e.g., for use during a vacation or business trip) and transported through hallways, elevators, and offices.

In all the above actions associated with a bike, there is one common problem. Bike pedals are often in the way and are relatively difficult to remove.

For example, when mounting a bike on a vehicle, the pedals can, and in many instances will, often scratch the vehicle, or strike the person mounting the bike. When storing bikes in garages, the pedals make storing the bikes close together difficult.

Further, when shipping a bike, the pedals often create problems placing the bike in a shipping container. When transporting bikes down hallways, the pedals often hit the legs of the person moving the bike.

Various retractile (or retractable) pedal systems have thus been designed to facilitate storing, shipping and transporting a bike. However, all of the systems possess serious disadvantages and drawbacks. A major drawback associated with retractable pedal systems is that most known systems require locking or tightening of the pedals upon folding or swiveling about an axis; in the operative and/or non-use position of the pedals. Both actions do, however, involve special and tiresome conversion operations to change the pedals from one position to the other.

A further drawback associated with retractable pedal systems is that several systems only provide partial retraction of the pedals, whereby a portion of each pedal remains projecting outwardly at right angles from the crank.

Thus, to facilitate storing, shipping and transporting of a bike, and/or mounting a bike on a vehicle, the pedals are often removed. However, removal of conventional pedals (having threaded mounting structures) typically requires special tools and time consuming operations. Removal of pedals to facilitate storing, shipping and transporting of a bike, and/or mounting a bike on a vehicle is thus often deemed inconvenient and undesirable from a practical standpoint.

Removal (and replacement) of pedals is also deemed highly inconvenient and undesirable for avid or competitive riders where quick substitution or replacement of pedals is often required (e.g. during a race) or desired (e.g. changing from racing pedals to riding pedals). Further, to substitute or replace conventional pedals at a recreation or other location, or during a ride or race, the special tools must be carried by the bike owner (or rider).

Various systems and means for rapidly removing pedals have thus been proposed. Illustrative is the pedal mounting structure disclosed in U.S. Pat. No. 6,874,387.

Referring to FIGS. 1 and 2, the pedal mounting structure disclosed in the '387 patent includes a male threaded pedal 10, a male threaded solid interchange connector plug 12, and a female threaded manual connect coupling 14, which is adapted to engage the crank (or crank arm) 18. As illustrated in FIG. 1, the bicycle pedal 10 has a male threaded shaft 16 that is adapted to engage the threaded female end 17 of the manual connect coupling 14.

As also illustrated in FIG. 1, the crank arm 18 has a female threaded screw hole 11 that is adapted to receive the connector plug threads 13 (disposed on the male threaded end thereof) and secure the connector plug 12 to the crank arm 18.

As illustrated in FIG. 2, the connector plug 12 seats inside the manual connect coupling 14 interior casing and is locked in position by ball bearings, which lock in a connector plug locking indent. The ball bearings lock and release mechanism is controlled by a slide sleeve 15 on the exterior portion of the manual connect coupling 14.

According to the invention, to release or disengage the connect coupling 14 (and, hence, pedal 10 connected thereto), the slide sleeve 15 is manually pulled back along the connector plug axis in the direction of the pedal 10, whereby internal springs contract. The ball bearings are then free to float within the coupling interior casing and the connector plug 12 can then be released or reconnected. When the slide sleeve 15 is released, spring tension forces the slide sleeve 15 forward along the connector plug axis to a retainer ring and the ball bearings are locked in position in the connector plug locking indent.

A major disadvantage and drawback of the noted pedal mounting structure, as well as most known pedal mounting and/or release structures, is that the structures comprise multiple complex components and assemblies. The structures are also generally expensive to manufacture.

A further disadvantage and drawback of most known pedal mounting and/or release structures is that the structure components are typically disposed on (and extend outwardly from) the outward facing side of the crank or crank arm. As a result, the structure produces a wider pedal stance and, hence, enhanced cantilever forces proximate the pedal-crank interface. Further, the structure can, and in many instances will, interfere with normal bike operation.

It would therefore be desirable to provide a pedal mounting structure and system that facilitates quick removal and replacement of pedals, requires minimal components for effective operation, does not increase the pedal stance, does not interfere with normal bike (or other apparatus) operation, can readily accommodate a multitude of pedals, requires minimal tools to remove and replace pedals, and is aesthetically clean.

### SUMMARY OF THE INVENTION

The present invention provides a pedal mounting structure and system that facilitates quick removal and replacement of pedals, requires minimal components for effective operation, does not increase the pedal stance, does not interfere with normal bike (or other apparatus) operation, and can readily accommodate a multitude of pedals.

The present invention also provides a pedal mounting structure and system that is adapted to quickly release and attach a multitude of “conventional” pedals to a bike crank with minimal, if any, tools. In one embodiment of the invention, the system generally includes a crank arm and an arm insert that is adapted to threadably engage a pedal. In a preferred embodiment, the crank arm includes a moveable retention clip that is configured to releasably secure the arm insert (and, hence, pedal engaged thereto) in the crank arm receiving hole, and a retention ball assembly that is configured and positioned to releasably secure the retention clip in a pedal locking position.

As set forth in detail herein, release of a pedal from a crank (and, hence, bike) merely requires “manually” moving a retention clip to a pedal release position and sliding the arm insert (and, hence, pedal engaged thereto) out of the crank arm hole. Attachment of a pedal merely requires attaching the arm insert on the pedal axle, sliding the arm insert (and, hence, pedal engaged thereto) into the crank arm hole, and “manually” moving the retention clip to a pedal locking position.

As will readily be appreciated by one having ordinary skill in the art, the present invention provides numerous advantages over conventional pedal mounting structures, as well as all known manually releasable pedal systems. Among the advantages are the following:
The provision of a pedal mounting structure and system that facilitates the “quick” release and attachment of pedals to a multitude of bikes, and other vehicles and apparatus;
The provision of a pedal mounting structure and system that facilitates the “quick” release and attachment of a multitude of pedals having various configurations to vehicles and other apparatus;
The provision of a pedal mounting structure and system that requires minimal components for effective operation;
The provision of a pedal mounting structure and system that does not increase the pedal stance;
The provision of a pedal mounting structure and system that does not increase the cantilever forces proximate the pedal-crank interface;
The provision of a pedal mounting structure and system that does not interfere with normal bike or other vehicle (or apparatus) operation;
The provision of a pedal mounting structure and system that requires minimal, if any, tools to release and attach pedals to a bike or other vehicle (or apparatus); and
The provision of a “quick release” crank mounting structure that facilitates the quick release and attachment of a multitude of bike pedals having various configurations to a bike crank.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a perspective, exploded view of a prior art releasable pedal mounting structure;

FIG. 2 is a further perspective view of the pedal mounting structure shown in FIG. 1 assembled and attached to a crank arm;

FIG. 3 is a side plane view of an assembled road bike;

FIG. 4 is a side plane view of a prior art crank and crank arm assembly;

FIG. 5 is perspective view of a prior art crank bottom bracket;

FIG. 6 is a back plane view of a crank arm, in accordance with one embodiment of the invention;

FIG. 7 is a front plane view of the crank arm shown in FIG. 6, in accordance with one embodiment of the invention;

FIGS. 8 and 9 are a partial perspective views of the crank arm shown in FIGS. 6 and 7, illustrating the lock and release of a pedal axle, in accordance with one embodiment of the invention;

FIGS. 10 and 11 are partial side views of the crank arm shown in FIGS. 6 and 7, illustrating the retention ball assembly, in accordance with one embodiment of the invention;

FIG. 12 is a perspective view the crank arm shown in FIG. 6 and a bike pedal positioned for engagement thereto, in accordance with one embodiment of the invention;

FIG. 13 is a perspective view of an arm insert and the threaded end of pedal axle, in accordance with one embodiment of the invention;

FIG. 14 is a perspective view of a partially sectioned crank arm, illustrating the engagement of the bike pedal shown in FIG. 12 engaged thereto, in accordance with one embodiment of the invention;

FIG. 15 is a further perspective view of the partially sectioned crank arm shown in FIG. 13, illustrating the pre/post-engagement position of the bike pedal shown in FIG. 12, in accordance with one embodiment of the invention;

FIG. 16 is a top plane view of a retention clip, in accordance with one embodiment of the invention;

FIG. 17 is a perspective view of the retention clip shown in FIG. 16, in accordance with one embodiment of the invention;

FIG. 18 is a back plane view of another embodiment of a crank arm, in accordance with the invention;

FIG. 19 is a front plane view of the crank arm shown in FIG. 18, in accordance with one embodiment of the invention;

FIG. 20 is a perspective view the crank arm shown in FIG. 18 and a bike pedal positioned for engagement thereto, in accordance with one embodiment of the invention;

FIG. 21 is a perspective view of another embodiment of an arm insert and the threaded end of pedal axle, in accordance with the invention; and

FIG. 22 is a section side (or end) view of the arm-retention clip assembly shown in FIG. 21, illustrating the clearance between the retention clip and arm, in accordance with one embodiment of the invention.

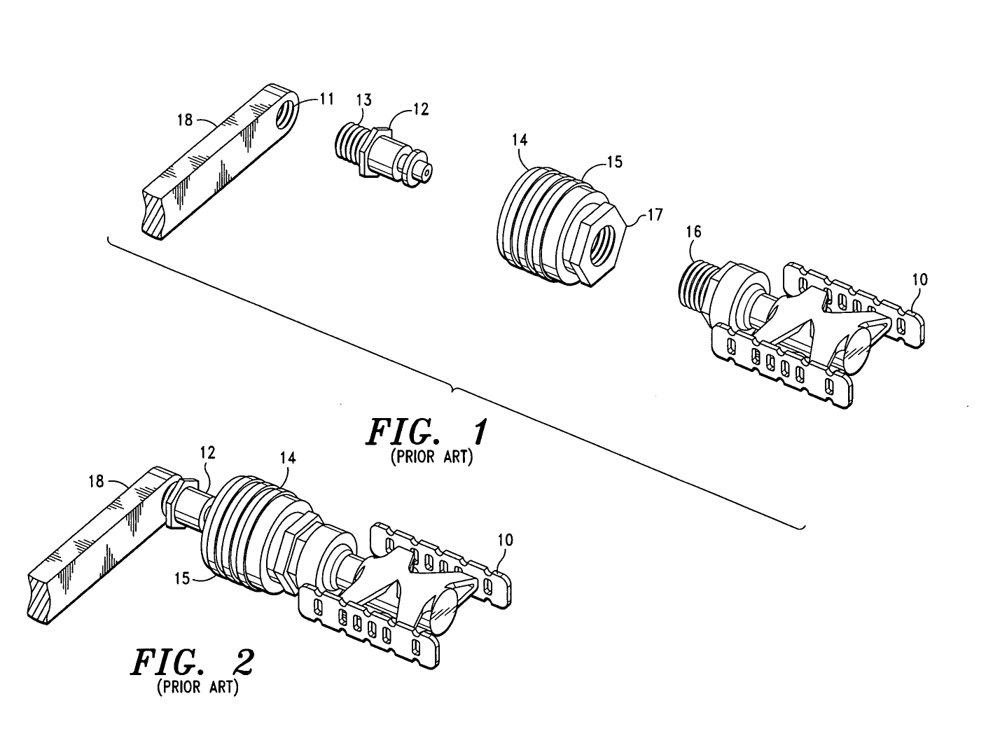

### DETAILED DESCRIPTION OF THE PREFERRED EMBODIMENT

Before describing the present invention in detail, it is to be understood that this invention is not limited to particularly exemplified apparatus, systems, structures or methods as such may, of course, vary. Thus, although a number of structures, systems and methods similar or equivalent to those described herein can be used in the practice of the present invention, the preferred structures, systems and methods are described herein.

It is also to be understood that, although the pedal mounting structures and systems of the invention are illustrated and described in connection with a conventional road bike, the pedal mounting structures and systems of the invention are not limited to a road bike. According to the invention, the pedal mounting structures and systems of the invention can be employed on any vehicle or apparatus having one or more pedals, including single and multi-wheeled vehicles that are manually powered or powered by a power source that is adapted to convert any of various forms of energy into mechanical force and motion, including, but not limited to, unicycles, road bikes, racing bikes, mountain bikes, electric bikes, and mopeds.

It is further to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Finally, as used in this specification and the appended claims, the singular forms “a, “an” and “the” include plural referents unless the content clearly dictates otherwise. Thus, for example, reference to “a fitting” includes two or more such fittings and the like.

### DEFINITIONS

The terms “bike” and “bicycle” are used interchangeably herein and mean and include any single or multi-wheeled vehicle that is manually powered or powered by a motor or engine, including, but not limited to, unicycles, road bikes, racing bikes, mountain bikes, electric bikes, and mopeds. The noted terms also include stationary apparatus, such as an exercise bike.

The following disclosure is provided to further explain, in an enabling fashion, the best modes of practicing one or more embodiments of the present invention. The disclosure is further offered to enhance the understanding of and appreciation for the inventive principles and advantages thereof, rather than to limit the invention in any manner. The invention is thus defined solely by the appended claims, including any amendments made during the pendency of this application, and all equivalents of those claims, as issued.

As will readily be appreciated by one having ordinary skill in the art, the present invention substantially reduces or eliminates the disadvantages and drawbacks associated with conventional systems and methods for attaching the pedals to a bike or other vehicle (e.g., moped) or apparatus (e.g., exercise bike).

As discussed in detail below, the pedal mounting structures and systems of the invention provide a rapid and effective means for removing, attaching and replacing virtually all desired pedals (having a threaded axle) and, hence, pedal configurations to virtually all styles and sizes of bikes, and other vehicles and apparatus. Thus, although the pedal mounting structures and systems of the invention are illustrated and described in connection with a conventional road bike, it is again emphasized that the pedal mounting structures and systems of the invention are not limited to a road bike. Indeed, as stated above, the pedal mounting structures and systems of the invention can be employed on any vehicle or apparatus having one or more pedals, including single and multi-wheeled vehicles that are manually powered or powered by a power source that is adapted to convert any of various forms of energy into mechanical force and motion, including, but not limited to, unicycles, road bikes, racing bikes, mountain bikes, electric bikes, and mopeds.

Referring now to FIG. 3, there is shown a side view of a conventional road bike 20. As illustrated in FIG. 3, the road bike 20 generally includes a frame 22, seat 23, handlebar unit 24, front and rear tires 26, 28, and front and rear brake assemblies 29a, 29b. The road bike 20 also includes a drive unit 30 that is adapted and configured to convert a rider's pedaling force into driving force.

The drive unit 30 that generally includes a front crankset 32, rear gear cassette unit 34, a chain 36, a front derailleur 37a, and a rear derailleur 37b. The front crankset 32 is typically operatively mounted on the bottom bracket 40 of the bike 20. The rear gear cassette unit 34 is mounted in a non-rotatable manner to the free hub of the rear wheel 28. The chain 36 is operatively connected to the front crankset 32 and the rear gear cassette unit 34 so as to span therebetween.

As illustrated in FIG. 3, the front crankset 32 generally includes a bottom bracket assembly 40, having a crank 42, a right crank arm 44, a left crank arm 46, and a pair of pedals 48. The bottom bracket assembly 40 also includes a crank spindle 50 that is rotatably encased within the bottom bracket shell. The right and left crank arms 44, 46 are removably fastened to the right and left ends of the spindle 50 with the pedals 48 mounted on the free ends of the right and left crank arms 44, 46.

Referring now to FIG. 5, there is shown an exemplar bottom bracket spindle 50. As illustrated in FIG. 5, the spindle 50 includes threaded engagement members 52a, 52b that are rotatably secured to opposing ends of the spindle 50 and are adapted to engage the bottom bracket shell. The end portions 54a, 54b of the spindle 50 are adapted to slidably receive the correspondingly shaped axle receiving openings (or holes) of the crank 42, and crank arms 44, 46 (see FIG. 4).

Each end portion 54a, 54b further includes an internal threaded engagement region 56 that is adapted to receive a fixed bolt (e.g., crank bolt) to secure the crank 42 and crank arms 44, 46 thereto.

As indicated, a major problem associated with the noted conventional pedals and threaded mounting structures is that removal and/or replacement of the pedals require special tools (which must often be carried) and time consuming operations to effectuate removal and/or replacement of the pedals. The present invention eliminates this problem by providing pedal mounting structures (and systems) that facilitate rapid release, removal, and attachment of a multitude of desired pedal configurations to a vehicle; particularly, a bike.

According to the invention, the pedal mounting structures (and systems) of the invention can be employed with virtually any conventional vehicle pedal mounting or support structures or arms. In one embodiment of the invention, wherein the vehicle comprises a bicycle, the pedal support structure thus comprises a crank arm.

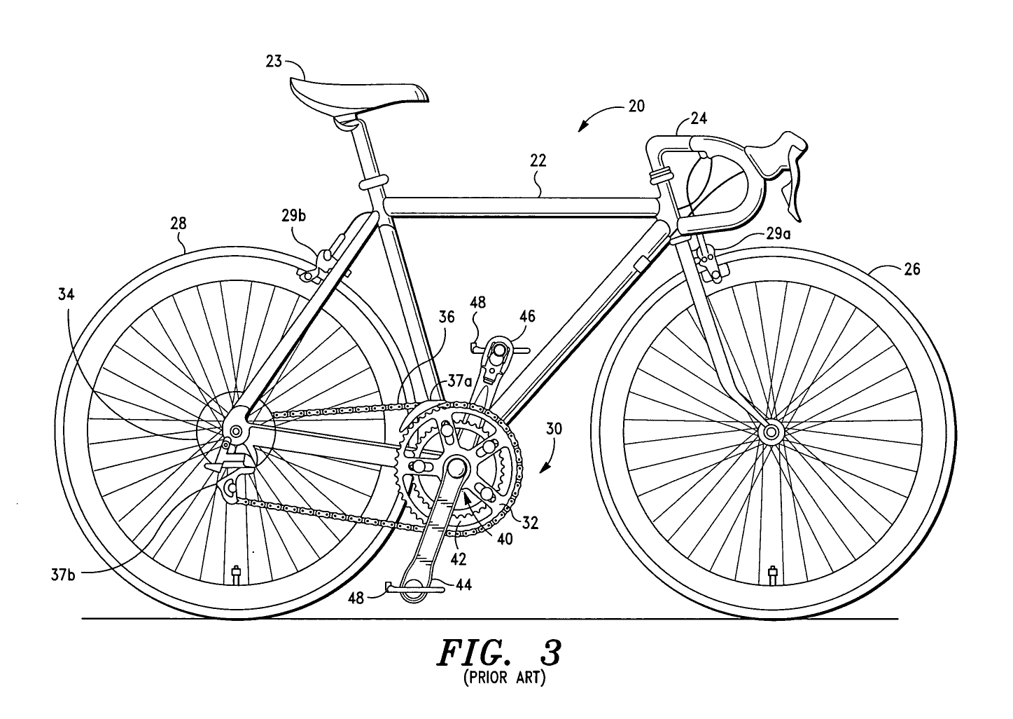

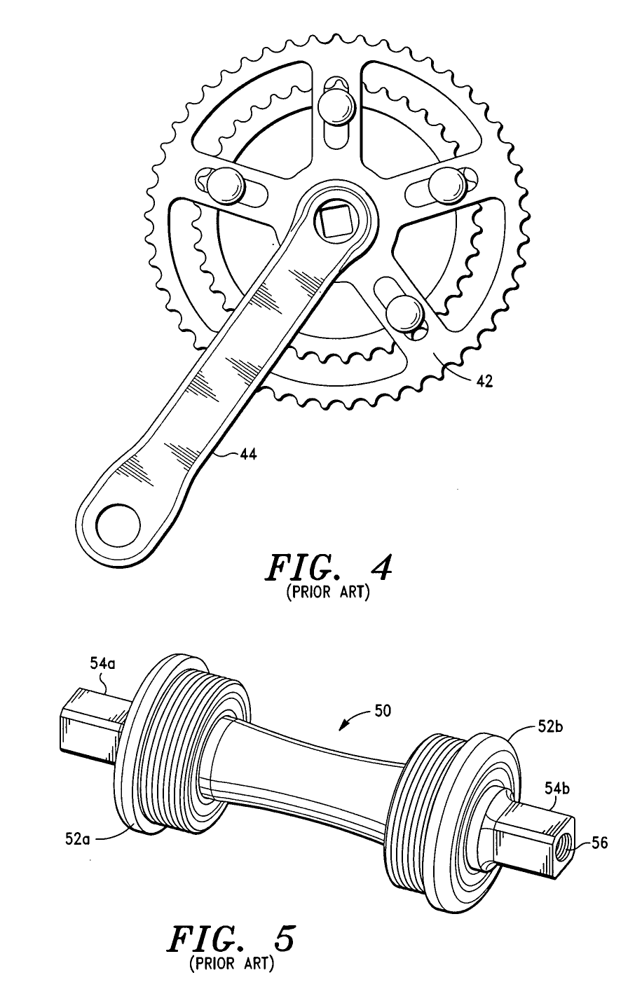

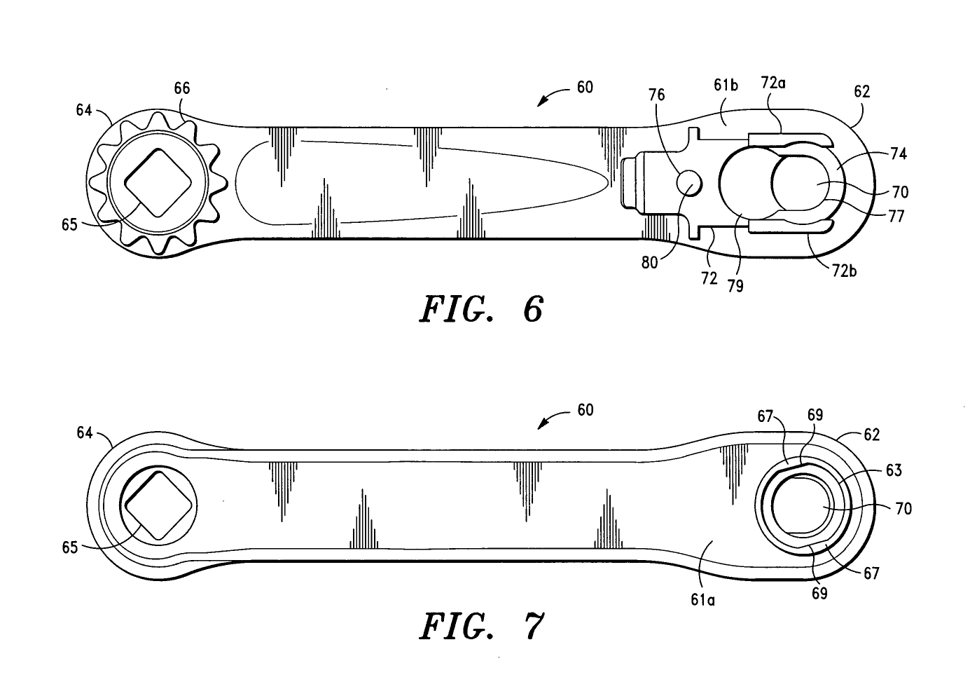

Referring now to FIGS. 6-14, one embodiment of a pedal mounting system of the invention will be described in detail. As set forth in detail below, the system (also referred to herein as a “crank mounting structure”) generally includes a crank arm that is adapted to cooperate with a bike crank and an arm insert that is adapted to threadably engage a pedal. In a preferred embodiment, the crank arm includes a moveable retention clip that is configured to releasably secure the arm insert (and, hence, pedal engaged thereto) in the crank arm receiving hole, and clip retention means adapted to releasably secure the retention clip in a pedal locking position. In one embodiment of the invention, the clip retention means comprises a retention ball assembly.

As set forth in detail herein, release of a pedal (with an engaged arm insert of the invention) merely requires moving the retention clip to a pedal release position and sliding the arm insert (and, hence, pedal engaged thereto) out of the crank arm hole. Attachment of the same pedal merely requires sliding the arm insert (and pedal engaged thereto) into the crank arm hole, and moving the retention clip to a pedal locking position. Attachment of a substitute or replacement pedal merely requires attaching an arm insert on the pedal axle, sliding the arm insert (and pedal engaged thereto) into the crank arm hole, and moving the retention clip to a pedal locking position.

Referring first to FIG. 6, there is shown one embodiment of a crank arm 60 (i.e. right crank arm) that can be employed with the crank mounting structure. As illustrated in FIG. 6, the crank arm 60 has a pedal engagement end 62 and a bottom bracket engagement end 64, which is configured and adapted to engage a bottom bracket spindle (such as spindle 50), as discussed above.

The bottom bracket engagement end 64 of the crank arm 60 also includes a raised region 66 (having a plurality of teeth) disposed proximate the crank axle receiving (square shaped) hole 65, which is configured and adapted to slideably engage a correspondingly shaped arm engagement region on the crank 42. As will readily be appreciated by those skilled in the art, the illustrated crank arm 60 with the raised region 66 is a unique Doug White Industries, Inc. crank arm.

Since the second (or left) crank arm includes a similar pedal engagement end 62 and the structure and axle engagement means are well known in the art, in the interest of brevity and minimization of any risk of obscuring the features and concepts of the invention, the crank mounting structures (and systems) of the invention will be illustrated and described in connection with only one crank arm, i.e. crank arm 60.

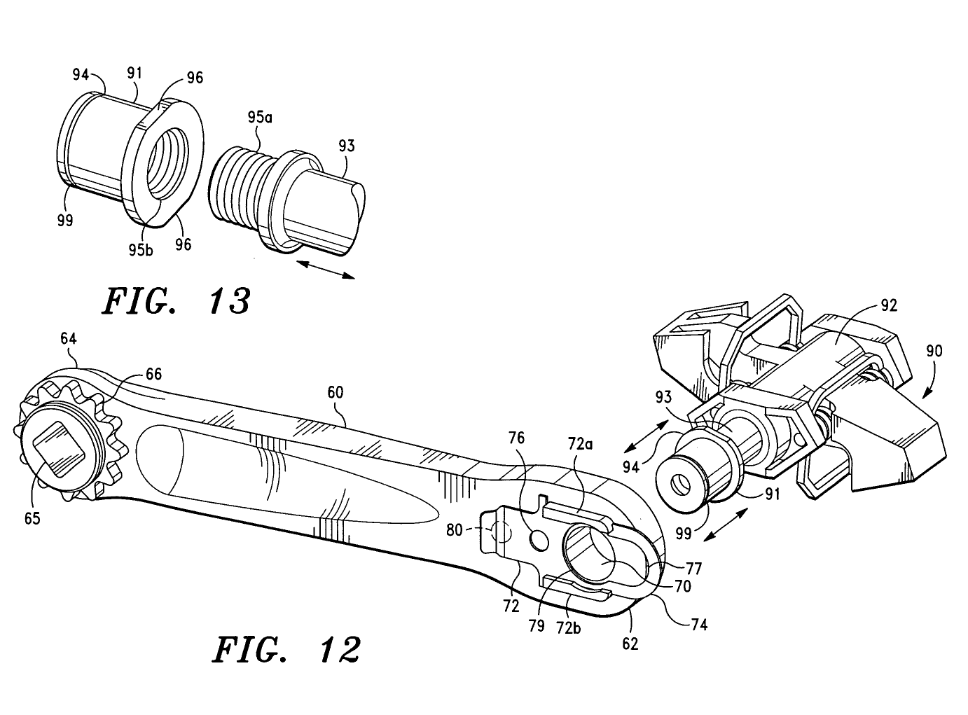

Referring now to FIG. 7, the pedal engagement end 62 of the crank arm 60 includes a pedal axle hole 70 that is adapted to slidably receive the arm insert 91 illustrated in FIG. 12 therein. As illustrated in FIG. 7, on a first side 61a of the pedal engagement end 62 proximate the axle hole 70 is an insert seat (i.e. recessed region) 63 that is configured and adapted to receive and seat arm insert 91 (see FIG. 13) therein.

In some embodiments (i.e. an option), the insert seat 63 includes means for abating rotation of the arm insert 91 when seated therein. As will readily be appreciated by one having ordinary skill in the art, various means can be employed (or incorporated in the seat 63) to abate rotation of the arm insert 91.

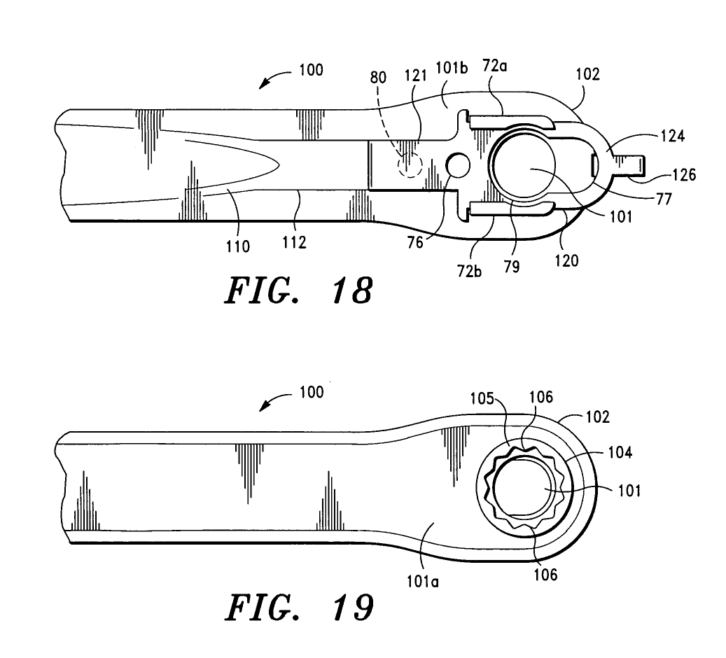

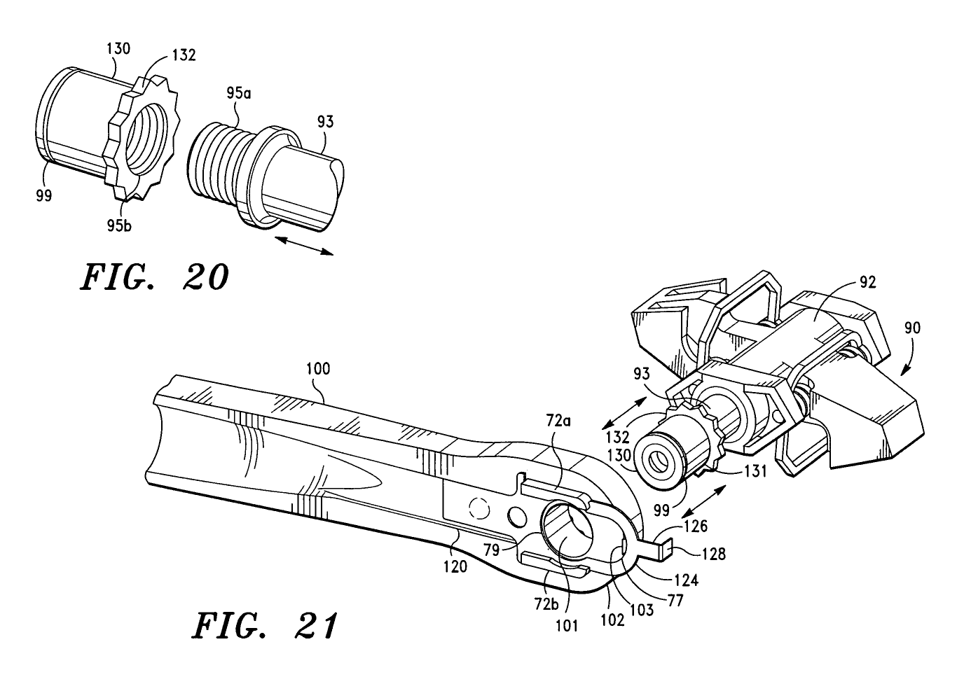

In some embodiments of the invention (discussed in detail below), the rotation abatement means comprises a plurality of raised projections (or teeth) that are adapted to cooperate with a correspondingly similar shaped region on a crank arm (see FIGS. 19 and 20).

In embodiment illustrated in FIG. 7, the rotational abatement means comprises at least one, preferably, two rotation stops 67 that project inwardly toward the axle hole 70. According to the invention, the stops 67 can comprise various configurations and be disposed in various positions in the seat 63. In the illustrated embodiment, the stops 67 are disposed at 180°. Each stop 67 also includes an inwardly facing substantially flat region 69.

According to the invention, the insert stop 94 includes a correspondingly similar shape as the insert seat 63 (with the rotation stops), whereby when the arm insert 91 is operatively positioned in seat 63 the flat regions 69 of stops 67 mate with the correspondingly similar shaped regions 96 on the insert stop 94 (see FIGS. 12-13) to abate rotation of the insert 91 and, hence, pedal axle 93, attached thereto.

Referring back to FIG. 6, disposed on a second side 61b of the pedal engagement end 62 are the primary structures and components of the unique pedal mounting structures of the invention. It is important to note that the structures and components of the pedal mounting structures would thus be disposed on the inwardly facing side of the crank arm 60 when the crank arm 60 is attached to the bike crank 42, thereby substantially reducing the possibility of interference with normal bicycle operation.

It is further important to note that the pedal mounting structures and systems of the invention have minimal, if any, effect on the original pedal stance. Indeed, in a preferred embodiment of the invention, the pedal mounting structures and systems of the invention do not increase the pedal stance.

As will thus be readily apparent to one having ordinary skill in the art, the pedal mounting structures and systems of the invention will not increase the cantilever forces that are typically realized at the pedal-crank arm interface.

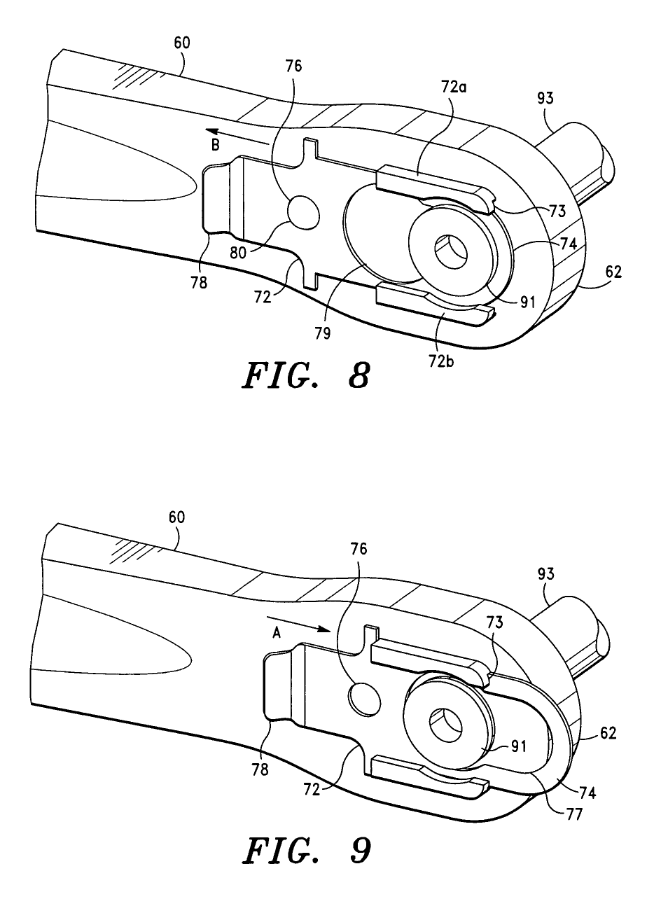

As illustrated in FIG. 6, the pedal engagement end 62 includes raised retention clip bosses 72a, 72b that are disposed on opposing sides of the pedal axle hole 70, a pedal retention clip 72, and a retention ball assembly 80. In a preferred embodiment, each clip boss 72a, 72b has a clip receiving slot 73 (see FIGS. 8-9) that is configured and adapted to slidably receive the clip insert (or axle) engagement end 74 (discussed below).

Referring to FIGS. 6 and 8-9, the retention clip 72 preferably comprises a substantially planar structure having an engagement end 74 and a retention ball receiving hole 76 that is configured and positioned to partially receive the retention ball 82 therein when (as discussed in detail below) the retention clip 72 is in a pedal engagement or locked position.

As illustrated in FIG. 6, the retention clip 72 further includes arm insert engagement and release regions, 77 and 79, respectively. As discussed in detail below, the insert engagement region 77 is adapted to engage the insert retention clip slot 99 when the insert 91 is positioned in the insert seat 63 and the retention clip 72 is in a pedal engagement or locked position. The insert release region 79 is adapted to release the insert 91 (and, hence, pedal engaged thereto) and allow the insert 91 to move through the clip 72 when the clip 72 is moved to a pedal release position.

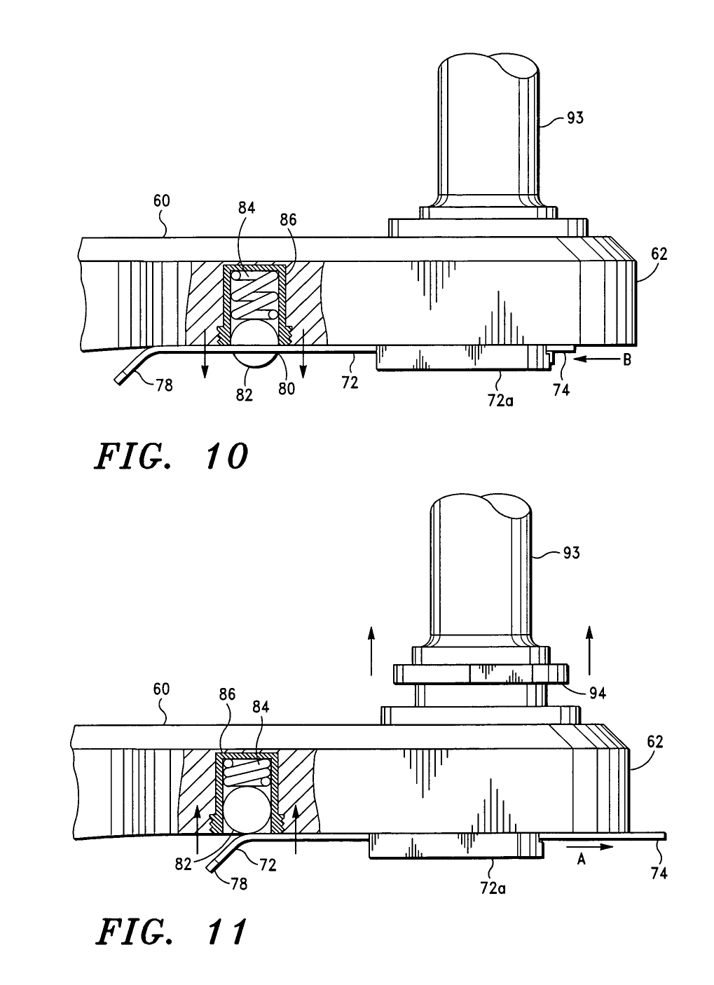

As illustrated in FIGS. 10 and 11, in some embodiments, the retention clip 72 also includes a downwardly projecting end 78 disposed opposite the engagement end 74 that facilitates manual positioning of the retention clip 72 to and from the pedal engagement and release positions.

Referring now to FIGS. 10-11, the retention ball assembly 80 includes the aforementioned retention ball 82, and a spring 84 and spring retainer 86. As illustrated in FIG. 10, the spring retainer 86 is designed and adapted to seat and position the spring 84 and ball 82 therein, whereby the ball 82 partially projects outwardly to a first released position (when the clip 72 is in a locking position) and is maintained in the released position by virtue of a spring force exerted by the spring 84.

As will readily be appreciated by one having ordinary skill in the art, the retention ball assembly 80 described above is but one means that can be employed to releasably secure the retention clip 72 in a locking position. Indeed, various other conventional means, such a pin assembly, can be employed within the scope of the invention to releasably secure the retention clip 72 in a locking position.

Referring now to FIG. 12, there is shown one embodiment of a pedal 90 that is designed and adapted to cooperate with the pedal mounting systems of the invention. As illustrated in FIG. 12, the pedal 90 includes a foot placement region 92 and an axle 93, having a conventional threaded end 95a that is adapted to threadably engage the internal threads 95b of insert 91 (see FIG. 13).

Referring to FIG. 13, disposed on one end of the insert 91 is a retention clip slot 99, which preferably extends about the entire outer periphery of the insert 91. According to the invention, the clip slot 99 is configured and adapted to receive the insert engagement region 77 of the retention clip 72 therein when the insert 91 is positioned in the pedal engagement end 62 of the crank arm 60 and the retention clip 72 is in a pedal engagement position.

Operation of the illustrated pedal mounting system described above will now be described in detail. It should be noted that the pedal release and attachment operations described below require minimal, if any, special tools.

Referring first to FIGS. 10 and 14, there is shown the retention clip 72 in a pedal engagement or locked position, whereby the retention ball 82 is seated in the clip retention ball receiving hole 76 and the engagement end 74 of the retention clip 72 is engaged in the clip slot 99 on the insert 91.

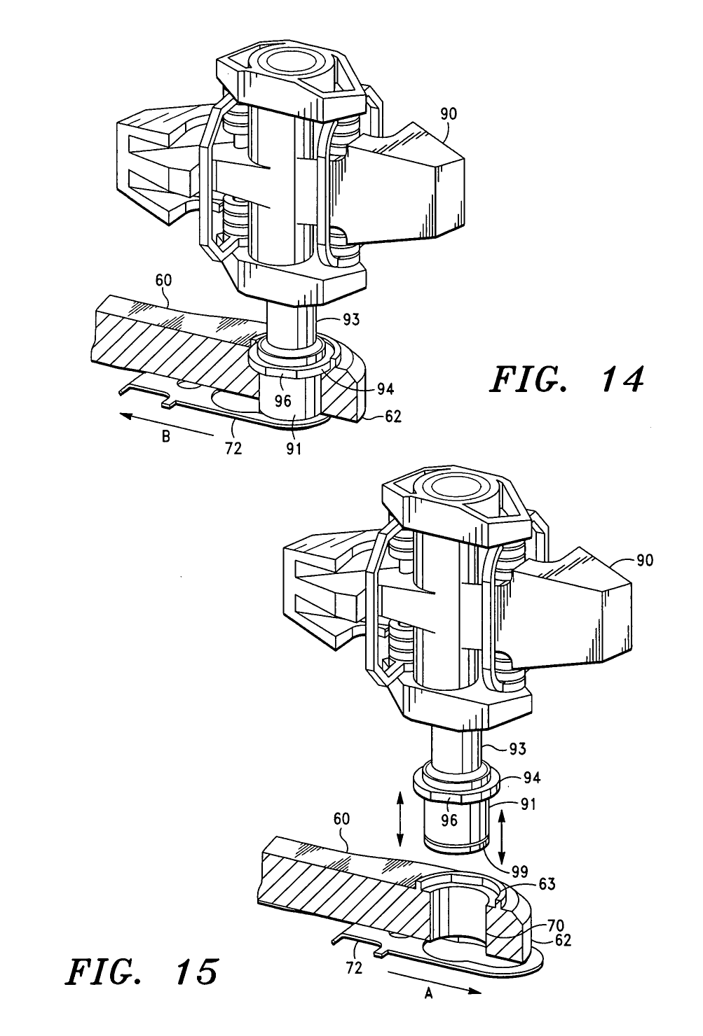

Referring now to FIGS. 9, 11 and 15, quick release of the pedal 90 from the crank arm 60 is achieved as follows: The retention clip 72 is manually moved in the direction denoted by Arrow A, whereby the retention ball 82 is released from the clip retention ball receiving hole 76 (and is urged into the spring retainer 86), and the insert engagement region 77 of the clip 72 is moved out of the clip slot 99 on insert 91. The insert 91 (with the pedal axle 93 engaged thereto) is then slid through the insert release region 79 of the clip 72 and out of the axle hole 70.

Referring to FIGS. 10, 13 and 14, re-attachment of the pedal 90 is achieved as follows: The insert 91 (and pedal 90 attached thereto) is inserted in the axle hole 70 to and until the insert stop 94 is operatively positioned in arm seat 63. The retention clip 72 is then moved in the direction denoted by Arrow B to and until the retention ball 82 is seated in the clip hole 76 and the clip 72 is engaged in the clip slot 99 on the insert 91.

Attachment of a replacement or substitute pedal merely requires placing an arm insert 91 on the axle of the replacement or substitute pedal, as illustrated in FIG. 13, and performing the same pedal engagement steps described above.

Referring now to FIGS. 16-22, there is shown another embodiment of a pedal mounting structure and system of the invention. According to the invention, and as will be readily apparent to one having ordinary skill in the art, operation of the pedal mounting structure embodiment shown in FIGS. 16-22 is similar to the operation of the pedal mounting structure embodiment shown in FIGS. 6-15 and discussed above.

Referring first to FIG. 19, the pedal engagement end 102 of the crank arm 100 similarly includes a pedal axle hole 101 that is adapted to slidably receive the arm insert 130 illustrated in FIGS. 20 and 21 therein. The first side 101a of the pedal engagement end 102 proximate the axle hole 101 also similarly includes an insert seat (i.e. recessed region) 104 that is configured and adapted to receive and seat arm insert 130 therein.

As illustrated in FIG. 19, the insert seat 104 also includes a rotation abatement region 105 that is designed and adapted to receive and cooperate with the raised projections (or teeth) 132 of the arm insert 130, whereby rotation of the arm insert 130 is abated when seated in the insert seat 104.

In the illustrated embodiment, the rotation abatement region includes at least one, preferably, a plurality of raised projections (or teeth) 106 that project inwardly toward the axle hole 101. In a preferred embodiment, the raised projections 106 have a correspondingly similar shape as the raised projections (or teeth) 132 of the arm insert 130 to facilitate cooperation therewith.

In some envisioned embodiments of the invention (not shown), the insert seat 104 further includes an o-ring seat proximate the base of the insert seat 104 that is adapted to receive and seat an o-ring therein. In this embodiment, the arm insert 130 would also include an o-ring seat proximate the base 131 of the arm insert 130 that would similarly be adapted to receive the o-ring, whereby upon operational engagement of the arm insert 130 to the crank arm 100, the o-ring would be seated in the crank arm and arm insert o-ring seats to provide motion and sound dampening.

Referring now to FIG. 18, the second side 101b of the crank arm pedal engagement end 102 similarly includes the raised retention clip bosses 72a, 72b, which are preferably disposed on opposing sides of the pedal axle hole 101, and the retention ball assembly 80. As illustrated in FIG. 18, the arm 101 also includes an extended recessed area 110, having a retention clip seat 112 on one end thereof. In some embodiments, as illustrated in FIG. 18, the retention clip seat 112 has a correspondingly similar shape (i.e. width) as the positioning end or region 121 of the retention clip 120.

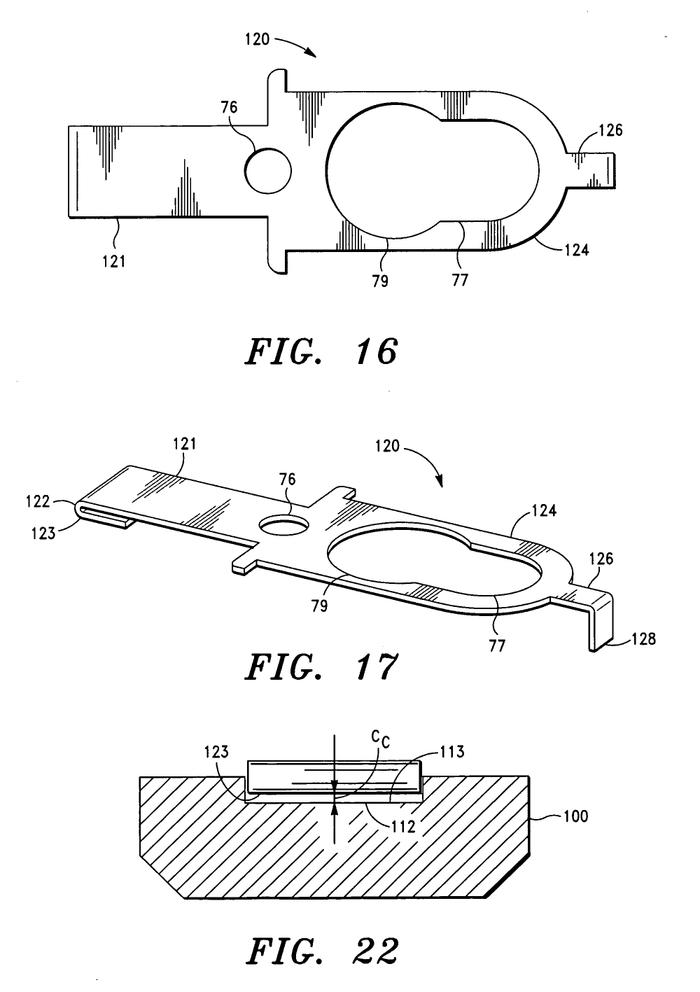

Referring to FIGS. 16 and 17, the retention clip 120 similarly comprises a substantially planar structure having the aforementioned positioning end 121, an engagement end 124 and the retention ball receiving hole 76 that is configured and positioned to partially receive the retention ball 82 therein when the retention clip 120 is in a pedal engagement position.

As illustrated in FIG. 17, in this embodiment, the positioning end 121 of the retention clip 120 also includes a inwardly projecting (i.e. finger grip) region 122 that facilitates manual positioning of the retention clip 120 to and from pedal engagement and release positions. To facilitate manual engagement of the finger grip region 122, in a preferred embodiment of the invention, the retention clip seat 112 has a depth that provides a clearance (denoted “C_{c}” in FIG. 22) of at least 2 mm from the bottom face 123 of the finger grip region 122 to the base 113 of the retention clip seat 112 when the retention clip 120 is operatively mounted on the crank arm 100.

As further illustrated in FIGS. 16 and 17, the engagement end 124 of the retention clip 120 also includes a clip position tab 126 having an inwardly projecting region 128 that is adapted to seat in the clip recess or stop 103 disposed on the pedal engagement end 102 of the crank arm 100 when the retention clip 72 is in a pedal engagement or locked position.

One having ordinary skill in the art will thus readily appreciate that the pedal mounting structures (and systems) of the invention provide numerous advantages over conventional pedals and mounting means therefore, as well as all know manually releasable pedal systems. Among the advantages are the following:
The provision of a pedal mounting structure and system that facilitates the “quick” release and attachment of pedals to a multitude of bikes, and other vehicles and apparatus;
The provision of a pedal mounting structure and system that facilitates the “quick” release and attachment of a multitude of pedals having various configurations to vehicles and other apparatus;
The provision of a pedal mounting structure and system that requires minimal components for effective operation;
The provision of a pedal mounting structure and system that does not increase the pedal stance;
The provision of a pedal mounting structure and system that does not increase the cantilever forces proximate the pedal-crank interface;
The provision of a pedal mounting structure and system that does not interfere with normal bike or other vehicle (or apparatus) operation;
The provision of a pedal mounting structure and system that requires minimal, if any, tools to release and attach pedals to a bike or other vehicle (or apparatus); and
The provision of a “quick release” crank mounting structure that facilitates the quick release and attachment of a multitude of bike pedals having various configurations to a bike crank.

Without departing from the spirit and scope of this invention, one of ordinary skill can make various changes and modifications to the invention to adapt it to various usages and conditions. As such, these changes and modifications are properly, equitably, and intended to be, within the full range of equivalence of any issued claims.

What is claimed is:

1. A releasable pedal mounting system for an apparatus having at least one pedal, the pedal having an engagement end, the pedal mounting system comprising:
a pedal adapter having first and second ends, said first adapter end being adapted to engage the pedal engagement end, said second adapter end including a retention region; and
a pedal support member having first and second ends, said first support member end including means for operatively connecting said support member to the apparatus, said second support member end including pedal adapter mounting means for releasably mounting said pedal adapter to said pedal support member, said pedal adapter mounting means including pedal adapter retention means for securing said pedal adapter to said pedal support member, said pedal adapter retention means being adapted to allow releasable mounting of said pedal adapter to said pedal support member when said pedal adapter retention means is in a first position and slideable engagement of said pedal adapter retention means to said pedal adapter retention region when said pedal adapter retention means is in a second position, whereby said pedal adapter is secured to said pedal support member in a locked position.

2. The system of claim 1, wherein said support member pedal adapter mounting means includes locking means for releasably securing said pedal adapter retention means in said second position.

3. The system of claim 1, wherein said locking means comprises a retention ball assembly.

4. The system of claim 1, wherein said support member pedal adapter mounting means includes rotation abatement means for abating rotation of said pedal adapter when mounted to said pedal adapter mounting means.

5. The system of claim 1, wherein the pedal engagement end includes an elongated threaded structure, and wherein said pedal adapter first end includes an internal threaded region that is adapted to cooperate with said pedal threaded structure.

6. The system of claim 1, wherein said pedal adapter retention means is disposed on an inward facing surface of said pedal support member.

7. The system of claim 1, wherein the apparatus comprises a bicycle.

8. The system of claim 7, wherein said pedal support member comprises a crank arm.

9. The system of claim 8, wherein said pedal adapter mounting means includes a crank arm lumen that is adapted to slideably receive said pedal adapter therein.

10. The system of claim 9, wherein said pedal adapter retention means comprises a substantially planar retention clip.

11. The system of claim 10, wherein said pedal adapter retention region includes a retention clip slot that is adapted to receive said retention clip therein when said pedal adapter retention means is in said second position.

12. The system of claim 10, wherein said pedal adapter mounting means includes retention clip guide means for guiding said retention clip.

13. A releasable pedal mounting system for an apparatus, comprising:
a pedal having an engagement end, said pedal engagement end including a retention region; and
a pedal support member having first and second ends, said first support member end including means for operatively connecting said support member to the apparatus, said second support member end including pedal mounting means for releasably mounting said pedal engagement end to said pedal support member, said pedal mounting means including pedal retention means for securing said pedal engagement end to said pedal support member, said pedal retention means being adapted to allow mounting of said pedal engagement end to said pedal support member when said pedal retention means is in a first position and slideable engagement of said pedal retention means to said pedal retention region when said pedal retention means is in a second position, whereby said pedal is secured to said pedal support member in a locked position.

14. The system of claim 13, wherein said support member pedal mounting means includes locking means for releasably securing said pedal retention means in said second position.

15. The system of claim 13, wherein said support member pedal mounting means includes rotation abatement means for abating rotation of said pedal engagement end when mounted to said pedal mounting means.

16. The system of claim 13, wherein said pedal retention means is disposed on an inward facing surface of said pedal support member.

17. The system of claim 13, wherein the apparatus comprises a bicycle.

18. The system of claim 17, wherein said pedal support member comprises a crank arm.

19. The system of claim 18, wherein said pedal mounting means includes a crank arm lumen that is adapted to slideably receive said pedal engagement end therein.

20. The system of claim 19, wherein said pedal retention means comprises a substantially planar retention clip.

21. The system of claim 20, wherein said pedal retention region includes a retention clip slot that is adapted to receive said retention clip therein when said pedal retention means is in said second position.
